(19) United States
(12) Patent Application Publication
(10) Pub. No.: US 2008/0242745 A1
(43) Pub. Date: Oct. 2, 2008

(54) AQUEOUS DISPERSION OF METAL OXIDE FINE PARTICLES AND METHOD FOR PRODUCING THE SAME

(75) Inventor: Kimiyasu Morimura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/036,384

(22) Filed: Feb. 25, 2008

(30) Foreign Application Priority Data
Mar. 29, 2007 (JP) 2007-087206

(51) Int. Cl. B01F 3/12

(52) U.S. Cl. 516/90; 516/88

(57) ABSTRACT

An aqueous dispersion of metal oxide fine particles, including metal oxide fine particles, a carboxylic compound and an acid compound containing a bulky anion having B value of −0.01 or less in Equation (1), wherein the metal oxide fine particles, the carboxylic compound and the acid compound containing a bulky anion are dispersed in an aqueous solution, and the aqueous dispersion of metal oxide fine particles has a light transmittance at 800 nm wavelength of 90% or more:

η=η⁰(1+A√c+Bc) Equation (1)
where η represents a viscosity of a solution, η⁰ represents a viscosity of a solvent, A and B respectively represent an inherent constant value of an acid, and c represents a concentration of the solution.

### BACKGROUND OF THE INVENTION

1. Field of the Invention

The present invention relates to a highly transparent aqueous dispersion of metal oxide fine particles in which metal oxide fine particles are dispersed with less aggregation, and a method for producing the aqueous dispersion of metal oxide fine particles.

2. Description of the Related Art

It is known that properties of metal oxide fine particles having a particle size of 100 nm or less are completely different from those having a particle size of more than 100 nm. Moreover, the metal oxide fine particles having a particle size of 100 nm or less are expected to have high catalytic property because a surface area per unit volume is extremely large, and a film is easily formed at a lower sintering temperature. Furthermore, they have high transparency in the visible range and a certain wavelength range, and can be widely used for optical filters, coatings, fibers, cosmetics or lenses.

In order to sufficiently exert these performances, the metal oxide fine particles are needed to be uniformly dispersed in a sol and base material without aggregation. However, the metal oxide fine particles having a large surface area per unit volume contribute to acceleration of aggregation, and the degree of aggregation is increased in accordance with increase of the concentration of an aqueous dispersion of metal oxide fine particles. Thus, there is a problem that sufficiently expected physical and optical performance may not be obtained.

Consequently, as a method for preventing aggregation in the aqueous dispersion of metal oxide fine particles, Japanese Patent Application Laid-Open (JP-A) No. 2004-59407 discloses in claims and examples use of a metal salt of aliphatic acid as a raw material of the metal oxide in metal oxide fine particles having improved cohesive property and the manufacturing method thereof. JP-A No. 2005-272244 discloses a method for synthesizing a solution of titanium dioxide nanoparticles, and in the paragraph [0012] discloses that a certain acid is coexisted. JP-A No. 2006-143535 discloses a zirconia sol having a uniform particle size distribution and excellent stability, a manufacturing method thereof, and in the paragraph [0011] discloses addition of carboxylic acid and followed by hydrothermal process.

These related arts are effective in producing an aqueous dispersion of metal oxide fine particles, but not sufficient enough to obtain a highly transparent aqueous dispersion of metal oxide fine particles in which metal oxide fine particles are dispersed with less aggregation, because function of an acid to be used is effective only as a dispersant, or an acid used alone is effective only as a hydrolysis promoter. Therefore, further improvement and development are demanded in the current situation.

### BRIEF SUMMARY OF THE INVENTION

The present invention aims to solve the conventional problems and achieve the following objects. Specifically, an object of the present invention is to provide a highly transparent aqueous dispersion of metal oxide fine particles in which metal oxide fine particles are dispersed with less aggregation, and a method for producing the aqueous dispersion of metal oxide fine particles.

To solve the above problems, inventors of the present invention have conducted extensive studies to prevent significant decrease of a sum of surface areas of all particles and impaired transparency, which is caused as a result that particles unintentionally interact with each other to aggregate and form secondary aggregate particles of big size in the aqueous dispersion of metal oxide fine particles. They found that metal oxide fine particles, a carboxylic compound (a carboxylic acid, salt of carboxylic acid, or carboxylic anhydride) and a specific acid compound containing a sterically-bulky anion are coexisted so as to obtain a highly transparent aqueous dispersion of metal oxide fine particles in which metal oxide fine particles are dispersed with less aggregation.

The present invention is based on the above-mentioned findings by the inventors of the present invention and the means for solving the above-mentioned problems is as follows:

<1> An aqueous dispersion of metal oxide fine particles, including metal oxide fine particles, a carboxylic compound and an acid compound containing a bulky anion having B value of −0.01 or less in Equation (1), wherein the metal oxide fine particles, the carboxylic compound and the acid compound containing a bulky anion are dispersed in an aqueous solution, and the aqueous dispersion of metal oxide fine particles has a light transmittance at 800 nm wavelength of 90% or more:

η=η⁰(1+A√c+Bc) Equation (1)

where q represents a viscosity of a solution, η⁰ represents a viscosity of a solvent, A and B respectively represent an inherent constant value of an acid, and c represents a concentration of the solution.

<2> The aqueous dispersion of metal oxide fine particles according to <1>, wherein the carboxylic compound is at least one selected from carboxylic acids, carboxylic anhydrides and salts thereof.
<3> The aqueous dispersion of metal oxide fine particles according to <1>, wherein the bulky anion is at least one selected from Br⁻, I⁻, PF₆⁻, ClO₃⁻, NO₃⁻, ClO₄⁻ and IO₄⁻.
<4> The aqueous dispersion of metal oxide fine particles according to <1>, wherein the metal oxide fine particles have a volume-weighted average particle size of 1 nm to 100 nm.
<5> The aqueous dispersion of metal oxide fine particles according to any of <1> to <4>, wherein a metal oxide constituting the metal oxide fine particles is any of a titanium oxide, a zirconium oxide and a composite oxide of titanium and zirconium.
<6> The aqueous dispersion of metal oxide fine particles according to any of <1> to <5>, wherein the metal oxide fine particles comprise crystalline metal oxide fine particles.
<7> A method for producing an aqueous dispersion of metal oxide fine particles including subjecting a metal oxide precursor to heat treatment in the presence of a carboxylic compound and an acid compound so as to prepare metal oxide fine particles, wherein the carboxylic compound is selected from carboxylic acids, carboxylic anhydrides and salts thereof, and the acid compound contains at least one counter ion selected from Br⁻, I⁻, PF₆⁻, ClO₃⁻, NO₃⁻, ClO₄⁻ and IO₄⁻.
<8> The method for producing an aqueous dispersion of metal oxide fine particles according to <7>, wherein the metal oxide precursor contains any of an organic metal compound, a metal salt and a metal hydroxide.

The present invention can solve the conventional problems and provide a highly transparent aqueous dispersion of metal oxide fine particles in which metal oxide fine particles are dispersed with less aggregation and a method for producing the aqueous dispersion of metal oxide fine particles.

### DETAILED DESCRIPTION OF THE INVENTION

### Aqueous Dispersion of Metal Oxide Fine Particles

An aqueous dispersion of metal oxide fine particles of the present invention contains metal oxide fine particles, a carboxylic compound and an acid compound containing a specific bulky anion, which are dispersed in an aqueous solution, and further contains other components, if necessary.

The aqueous dispersion of metal oxide fine particles has a light transmittance at 800 nm wavelength of 90% or more, and preferably 95% or more.

The light transmittance is measured, for example, in such a manner that distilled water is used as a reference, and the aqueous dispersion of metal oxide fine particles are poured into a quartz cell having an optical path length of 1 cm and measured on a spectrophotometer U-3310 from Hitachi, Ltd.

### <Metal Oxide Fine Particles>

A metal oxide contained in the metal oxide fine particles is not particularly limited, and may be appropriately selected depending on the purpose. Examples thereof include a titanium oxide, a zirconium oxide, a composite oxide of titanium and zirconium, and a composite oxide of titanium, zirconium and hafnium. Examples of metals contained in the metal oxide include titanium, zirconium, hafnium, tin, silicon, aluminum, zinc and barium. Of these, a titanium oxide, a zirconium oxide, and a composite oxide of titanium and zirconium are particularly preferred.

The metal oxide may contain other metallic elements as a dopant. The kinds and content of the metallic element to be added may be appropriately selected depending on the purpose. For example, the titanium oxide fine particles can be doped with 0.1 atomic % to 10 atomic % of at least one metallic element selected from Fe, Co, Ni, Cu, Zn, Nb, Y, Rh, Pb, Ag, Ta, Pt and Au.

Moreover, the titanium oxide fine particles may be coated with at least one oxide or hydroxide of a metal selected from silicon, aluminum, zinc, tin and zirconia in terms of photocatalytic property (right resistance).

The metal oxide fine particles have a volume-weighted average particle size of preferably 1 nm to 100 nm, more preferably 1 nm to 50 nm, still more preferably 1 nm to 20 nm, and particularly preferably 1 nm to 10 nm.

The volume-weighted average particle size of the metal oxide fine particles may be obtained by measuring a 4 mass % aqueous solution of metal oxide fine particles directly on a particle size distribution measuring device, Microtrac from NIKKISO Co., Ltd.

The metal oxide fine particles may preferably contain crystalline metal oxide fine particles. The metal oxide fine particles are not necessarily crystalline, but preferably crystalline to exert physical and optical properties for the purpose of obtaining high catalytic property, low sintering temperature and high refractive index. For example, titanium dioxide preferably has an anatase or rutile structure.

Here, as a common method for confirming crystallinity of the metal oxide fine particles, X-ray diffraction spectrum method is used. The presence or absence of crystallinity can be confirmed by the consistency with the peak of a corresponding single crystal by using RINT 1500 from Rigaku Corporation (X-ray source: copper Kα ray, wavelength: 1.5418 Å).

The aqueous dispersion of metal oxide fine particles is preferably a dilute solution containing less than 0.1 mass % of the metal oxide fine particles in terms of preventing aggregation thereof. In terms of dispersing the metal oxide fine particles in a sol or base material, a too much diluted solution may put a load in a subsequent concentrating step, thus the content of the metal oxide fine particles in the aqueous dispersion is more preferably 0.1 mass % to 20 mass %.

### <Carboxylic Compound>

As the carboxylic compound, at least one selected from carboxylic acids, salts of carboxylic acids and carboxylic anhydrides are used.

### —Carboxylic Acid—

The carboxylic acid is not particularly limited, and may be appropriately selected depending on the purpose. Examples thereof include saturated aliphatic carboxylic acids such as formic acid, acetic acid, propionic acid, butyric acid, isobutyric acid, valeric acid, isovaleric acid, pivalic acid, caproic acid, caprylic acid, capric acid, malonic acid, succinic acid, glutaric acid, adipic acid, pimelic acid and suberic acid; unsaturated aliphatic carboxylic acids such as acrylic acid, propiolic acid, methacrylic acid, crotonic acid, isocrotonic acid, maleic acid and fumaric acid; hydroxy carboxylic acids such as lactic acid, tartaric acid, malic acid and citric acid. These may be used alone or in combination of two or more.

The content of the carboxylic acid in the aqueous dispersion of metal oxide fine particles differs depending on the kinds or sizes of produced metal oxide fine particles and cannot be generally defined, and it is preferably 0.15 mole to 3 mole per 1 mole of metal.

### —Salt of Carboxylic Acid—

By dissociation of salt, the salts of carboxylic acids substantially show the same effect as corresponding carboxylic acids.

Examples of the carboxylic acids in the salts of carboxylic acids include those described in the carboxylic acids.

In the salts of carboxylic acids, examples of parts other than the carboxylic acid include Li, Na, K, NH₄, NH₃CH₂CH₂OH, NH₂(CH₂CH₂OH)₂ and NH(CH₂CH₂OH)₃.

The content of the salt of carboxylic acid in the aqueous dispersion of metal oxide fine particles differs depending on kinds or sizes of produced metal oxide fine particles and cannot be generally defined, and it is preferably 0.15 mole to 3 mole per 1 mole of metal.

### —Carboxylic Anhydride—

In an aqueous solution, the carboxylic anhydride, in which 2 molecules of carboxylic acid are condensed by losing one molecule of water, substantially shows the same effect as corresponding carboxylic acids.

The carboxylic anhydride is not particularly limited and may be appropriately selected depending on the purpose. Examples of the carboxylic anhydrides include acetic anhydrides, propionic anhydrides, succinic anhydrides, maleic anhydrides and phthalic anhydrides. These may be used alone or in combination of two or more.

The content of the carboxylic anhydride in the aqueous dispersion of metal oxide fine particles differs depending on kinds and sizes of produced metal oxide fine particles and cannot be generally defined, and it is preferably 0.075 mole to 1.5 mole per 1 mole of metal.

### <Acid Compound Containing a Bulky Anion>

The acid compound containing a bulky anion contains an anion having B value of −0.01 or less in Equation (1) by Jones and Dole.

η=η⁰(1+A√c+Bc) Equation (1)

where η represents a viscosity of a solution, η⁰ represents a viscosity of a solvent, A and B respectively represent an inherent constant value of an acid, and c represents a concentration of the solution.

Here, B value relates to the degree of steric bulkiness of anion. The larger negative value the B value is, the more sterically-bulky the anion is (G. Jones and M. Dole, J. Am. Chem. Soc., 51 2950 (1929)). According to the HSAB theory, the acid compound becomes soft as the anion becomes sterically-bulky. It is considered that aggregation of the metal oxide fine particles can be suppressed by decreasing a viscosity of the aqueous dispersion of metal oxide fine particles, because these anions have a small amount of hydrated water molecules.

Examples of the bulky anions having the B value of −0.01 or less include Br⁻ (−0.042), I⁻ (−0.068), PF₆⁻ (−0.021), Clo₃⁻ (−0.024), NO₃⁻ (−0.046), ClO₄⁻ (−0.056) and IO₄⁻ (−0.065). On the other hand, Cl⁻ (−0.007) and F⁻ (+0.096), which have the B value of more than −0.01, are not included in the bulky anion in the invention.

Examples of the acid compounds containing the bulky anion include HBr, HI, HPF₆, HClO₄, HClO₃, HNO₃, HIO₄ and salts thereof. Examples of parts of the salts thereof include Li, Na, K, NH₄, NH₃CH₂CH₂OH, NH₂(CH₂CH₂OH)₂ and NH(CH₂CH₂OH)₃.

The content of the acid compound containing a bulky anion in the aqueous dispersion of metal oxide fine particles differs depending on kinds and sizes of produced metal oxide fine particles and cannot be generally defined, and it is preferably 0.1 mole to 5 mole, more preferably 0.2 mole to 2 mole, and still more preferably 0.5 mole to 1.2 mole per 1 mole of metal.

### <Dispersing Solvent>

As a dispersing solvent, water is used, and other solvents can be added, if necessary. The solvents other than water are preferably compatible with water. Examples thereof include alcohols, ketones, aldehydes, ethers and esters.

Examples of alcohols include methanol, ethanol, propanol, isopropanol and butanol.

Examples of ketones include acetone and methyl ethyl ketone.

Examples of ethers include dioxane and diethyl ether. (Method for producing an aqueous dispersion of metal oxide fine particles)

A method for producing an aqueous dispersion of metal oxide fine particles of the present invention includes a step of preparing metal oxide fine particles and further includes other steps, if necessary.

### <Step of Preparing Metal Oxide Fine Particles>

The step of preparing metal oxide fine particles is a step in which a metal oxide precursor is subjected to heat treatment in the presence of at least one carboxylic compound selected from carboxylic acids, carboxylic anhydrides and salts thereof and an acid compound containing at least one counter ion selected from Br⁻, I⁻, PF₆⁻, ClO₃⁻, NO₃⁻, ClO₄⁻ and IO₄⁻ so as to prepare metal oxide fine particles.

In the method for producing an aqueous dispersion of metal oxide fine particles, it is preferred that a carboxylic compound (a carboxylic acid, salt of carboxylic acid, or carboxylic anhydride) be added and a certain sterically-bulky acid compound be also added before subjecting to the heat treatment in the step of preparing the metal oxide fine particles, in terms of preventing aggregation of particles.

The carboxylic compound and acid compound containing a bulky anion may be appropriately selected from those mentioned above.

The metal oxide precursor preferably contains, for example, any of an organic metal compound, a metal salt and a metal hydroxide.

The metal oxide precursor may be solid or liquid, and preferably water soluble and treated as an aqueous solution.

The metal component of the metal salt is a metal component of a corresponding metal oxide.

Examples of the metal salts include chlorides, bromides, iodides, nitrates, sulfates and organic acid salt of desired metals. Examples of the organic acid salts include acetate, propionate, naphthenate, octoate, stearate and oleate.

Examples of the metal hydroxides include amorphous titanium hydroxides in which a titanium tetrachloride solution is neutralized with an alkaline solution, zirconium hydroxides, and a composite hydroxide of titanium and zirconium.

Examples of the organic metal compounds include metal alkoxy compounds and metal acetylacetonate compounds.

Examples of the metal alkoxy compounds include tetraalkoxytitaniums and alkoxyzirconiums.

Examples of tetraalkoxytitaniums include tetramethoxytitanium, tetraethoxytitanium, tetrapropoxytitanium, tetraisopropoxytitanium, tetrabutoxytitanium, tetraisobutoxytitanium, tetrakis(2-methylpropoxy) titanium, tetrakis pentoxy titanium, tetrakis(2-ethylbutoxy) titanium, tetrakis(octoxy)titanium and tetrakis(2-ethylhexoxy) titanium. The tetraalkoxytitanium having too many number of carbon atoms in an alkoxyl group may not sufficiently undergo hydrolysis. The tetraalkoxytitanium having too small number of carbon atoms in an alkoxyl group may have high reactivity and be difficult to control reaction. Therefore, tetrapropoxytitanium and tetraisopropoxytitanium are particularly preferred.

Examples of alkoxyzirconiums include methoxyzirconium, ethoxyzirconium, propoxyzirconium, buthoxyzirconium, isobuthoxyzirconium and kis(2-methylpropoxy)zirconium. Of these, buthoxyzirconium is particularly preferred.

The method for producing an aqueous dispersion of metal oxide fine particles of the present invention specifically includes the following embodiments:

(1) An aqueous solution of an organic metal compound and a carboxylic compound are mixed at room temperature and stirred for 10 minutes. And then water is added therein and stirred for 30 minutes, an acid compound containing a bulky anion is added and subjected to heat treatment to produce an aqueous dispersion of metal oxide fine particles.

A method for producing an aqueous dispersion of metal oxide fine particles (1′), in which the timing of addition of the carboxylic compound in (1) is changed, is also preferably used:

(1′) An aqueous solution of an organic metal compound and water are added at room temperature and stirred for 30 minutes. And then, a carboxylic compound and an acid compound are added therein and subjected to heat treatment to produce an aqueous dispersion of titanium oxide fine particles.

In (1) and (1′), as the organic metal compound, an alkoxide compound of a desired metal is preferred. For example, titanium tetraisopropoxide is used as a titanium oxide, and zirconium butoxide is used as a zirconium oxide.

The carboxylic compound and the acid compound containing a bulky anion may be appropriately selected from those mentioned above. Examples of the carboxylic compounds include acetic acid, propionic acid, malic acid, butyric acid and salts thereof, and a succinic anhydride. Examples of the acid compounds containing a bulky anion include HPF₆, HCIO₄, HNO₃ and HIO₄.

The heat treatment is preferably performed using an oil bath at 30° C. to 98° C. for 5 minutes to 500 minutes.

(2) A titanium tetrachloride solution is kept at room temperature and neutralized with an alkaline solution to separate out an amorphous titanium hydroxide. The amorphous titanium hydroxide is heated and a precipitate is filtrated using distilled water and then a filter cake is washed. Subsequently, a carboxylic compound and an acid compound containing a bulky anion are added therein, and subjected to heat treatment to produce an aqueous dispersion of titanium oxide fine particles.

A method for producing an aqueous dispersion of titanium oxide fine particles (2′), in which the timing of addition of the acid compound containing a bulky anion in (2) is changed, is also preferably used:

(2′) A titanium tetrachloride solution is kept at room temperature and neutralized with an alkaline solution to separate out an amorphous titanium hydroxide. A carboxylic compound is added therein and heated. And then an acid compound containing a bulky anion (¼ amount) is added and subjected to heat treatment, and this process is repeated 4 times (i.e. the total amount of acid compound containing a bulky anion is added) to produce an aqueous dispersion of titanium oxide fine particles.

Examples of the alkaline solutions include aqueous solutions of alkaline metal salt such as a NaOH aqueous solution, KOH aqueous solution, aqueous ammonia and an aqueous solution of organic amine.

The washing method is not particularly limited and those known methods may be used as long as excess ions can be removed. Examples thereof include an ultrafiltration membrane method, a filtration separation method, a centrifugal separation-filtration method and an ion-exchange resin method.

The carboxylic compound and acid compound containing a bulky anion may be appropriately selected from those mentioned above. Examples of the carboxylic compounds include acetic acid, tartaric acid, citric acid and salts thereof, and an acetic anhydride. Examples of the acid compounds containing a bulky anion include HBr, HI, HClO₃, HClO₄, HNO₃ and HIO₄.

The heat treatment is preferably performed using a water bath at 30° C. to 98° C. for 5 minutes to 500 minutes.

(3) A carboxylic compound is added in an aqueous solution of an organic metal compound and stirred for 10 minutes, and then an aqueous solution of an acid compound containing a bulky anion is added to obtain a suspension. The suspension is loaded in an autoclave and subjected to hydrothermal treatment under pressure to produce an aqueous dispersion of metal oxide fine particles.

In (3), as the organic metal compound, an alkoxide compound of a desired metal is preferred. For example, titanium tetraisopropoxide is used as a titanium oxide, and zirconium butoxide is used as a zirconium oxide.

The carboxylic compound and the acid compound containing a bulky anion may be appropriately selected from those mentioned above. Examples of the carboxylic compounds include acetic acid, tartaric acid, malic acid and salts thereof, and an acetic anhydride. Examples of the acid compounds containing a bulky anion include HClO₄ and HNO₃.

### <Applications>

The aqueous dispersion of metal oxide fine particles of the present invention can be used as it is or condensed to be used as an aqueous dispersion. In addition, a binder component (resin component) is added to the aqueous dispersion of metal oxide fine particles to prepare a composition for film deposition (coating composition), and it is coated on a base material to form a fine particle dispersed film. Alternatively the aqueous dispersion of metal oxide fine particles is contained in a binder component (resin component) so as to prepare a resin composition for molding. Moreover, the aqueous dispersion of metal oxide fine particles is also prepared as a powder of fine particles by removing a solvent by concentration and drying, or centrifugation, and then by heating and drying.

The binder component is not particularly limited and may be appropriately selected depending on the purpose. Examples thereof include various kinds of synthetic resins such as thermoplastic or thermosetting resins (including thermosetting, ultraviolet curable, electron beam curable and moisture-curable resins, and combinations thereof), for example, silicon alkoxide binders, acrylic resins, polyester resins, fluorine resins, and organic binders such as natural resins. Examples of the synthetic resins include alkyd resins, amino resins, vinyl resins, acrylic resins, epoxy resins, polyamide resins, polyurethane resins, thermosetting unsaturated polyester resins, phenol resins, chlorinated polyolefin resins, silicone resins, acrylic silicone resins, fluorine resins, xylene resins, petroleum resins, ketone resins, rosin-modified maleic resins, liquid polybutadienes and coumarone resins. Examples of the natural resins include shellacs, rosins (pine resins), ester gums, hardened rosins, decolored shellacs and white shellacs. These may be used alone or in combination of two or more.

When the metal oxide fine particles are dispersed in a resin composition, the metal oxide fine particles are formulated with a dispersant, oil component, surfactant, pigment, preservative, alcohol, water, thickener or humectant, and used in various forms such as a dilute solution, tablet, lotion, cream, paste or stick, if necessary. The dispersant is not particularly limited and may be appropriately selected depending on the purpose. Examples thereof include a compound having a phosphoric acid group, a polymer having a phosphoric acid group, a silane coupling agent and a titanium coupling agent.

The aqueous dispersion of metal oxide fine particles of the present invention may be preferably used for optical filters, coatings, fibers, cosmetics, lenses or the like, because it has excellent dispersion stability and high transparency in the visible range and a certain wavelength range.

### EXAMPLES

Examples of the present invention will be described below, however, the present invention is not limited in scope to these Examples at all.

### Example 1

### Production of Aqueous Dispersions 1 to 14

According to the description of Table 1, 30 cc of titanium tetraisopropoxide (from Wako Pure Chemical Industries, Ltd.) and a carboxylic compound were mixed at room temperature (26° C.) and stirred for 10 minutes. Next, 180 cc of water was added therein and stirred for 30 minutes, and then an acid compound containing a bulky anion was added, and subjected to heat treatment at 120° C. for 10 minutes in an oil bath to produce respective aqueous dispersions of titanium oxide fine particles (hereinafter, a timing of addition of the carboxylic compound: A). Alternatively, 30 cc of titanium tetraisopropoxide (from Wako Pure Chemical Industries, Ltd.) and 180 cc of water were mixed at room temperature (26° C.), and stirred for 30 minutes, and then a carboxylic compound and an acid compound containing a bulky anion were added therein and subjected to heat treatment at 120° C. for 10 minutes in an oil bath to produce respective aqueous dispersions of titanium oxide fine particles (hereinafter, a timing of addition of the carboxylic compound: B).

The respective aqueous dispersions were air dried to obtain titanium oxide ultrafine particles, and the respective collected titanium oxide ultrafine particles were confirmed to have anatase crystal structures by X-ray diffraction.

Table 1 shows the kinds of the carboxylic compound, the contents of the carboxylic compound (mole) relative to the content of the titanium (mole), the timings of addition of the carboxylic compound (the carboxylic compound was added at the timing of addition A or B), the kinds of the acid compound containing a bulky anion, and the contents of the acid compound (mole) relative to the content of the titanium (mole), which were used for respective aqueous dispersions. Moreover, Table 1 shows respective results of an average size of 150 titanium oxide ultrafine particles found by TEM observation, and a transmittance at 800 nm wavelength of 4 mass % of the aqueous dispersions (optical path length of 1 cm).

The obtained aqueous dispersions of titanium oxide fine particles were respectively air dried to obtain titanium oxide fine particles.

The crystallinity, volume-weighted average particle size and light transmittance of the respective titanium oxide fine particles were measured as described below. The results are shown in Table 1.

### <Measurement of X-Ray Diffraction (XRD) Spectrum>

The obtained titanium oxide fine particles were respectively measured at 23° C. on RINT 1500 from Rigaku Corporation (X-ray source: copper Ka ray, wavelength: 1.5418 Å) to obtain X-ray diffraction (XRD) spectra. All of them were anatase titanium oxides (crystallinity).

### <Measurement of Volume-Weighted Average Particle Size>

The aqueous dispersion to be measured was dropped onto a carbon-deposited copper mesh (microgrid) and dried, and then observed at 5 fields of views or more at a magnification of ×25,000 by using a transmission electron microscope H-9000 UHR Model from Hitachi, Ltd. (accelerating voltage: 200 kV, degree of vacuum in observation: about 7.6×10⁻⁹ Pa) to obtain a volume-weighted average particle size of 150 titanium oxide fine particles.

### <Measurement of Light Transmittance>

Each of the aqueous dispersions containing 4 mass % of the obtained titanium oxide fine particles and distilled water as a reference were respectively poured into quartz cells having an optical path length of 1 cm and measured for a light transmittance at 800 nm wavelength on a spectrophotometer U-3310 from Hitachi, Ltd.

TABLE 1

| | Carboxylic acid compound | | | | B value | Content | Average | Transmittance | |
|---|---|---|---|---|---|---|---|---|---|
| | | Content | Timing of | Kind of | of acid | of acid | particle size | at 800 nm | |
| | Kind | (mol fr.) | additon | acid | (*) | (mol fr.) | (nm) | wavelength (%) | |
| Aqueous | — | 0 | — | — | — | 0 | 100 or more | 54 | Comparative |
| dispersion 1 | | | | | | | | | Example |
| Aqueous | — | 0 | — | HCl | −0.007 | 0.45 | 65 | 73 | Comparative |
| dispersion 2 | | | | | | | | | Example |
| Aqueous | acetic acid | 0.95 | A | — | — | 0 | 88 | 60 | Comparative |
| dispersion 3 | | | | | | | | | Example |
| Aqueous | acetic acid | 0.95 | A | HCl | −0.007 | 0.45 | 59 | 80 | Comparative |
| dispersion 4 | | | | | | | | | Example |
| Aqueous | acetic acid | 0.95 | A | HPF₆ | −0.021 | 0.45 | 22 | 92 | Example |
| dispersion 5 | | | | | | | | | |
| Aqueous | propionic acid | 1.1 | A | HPF₆ | −0.021 | 0.45 | 28 | 90 | Example |
| dispersion 6 | | | | | | | | | |
| Aqueous | acetic acid | 0.95 | B | HPF₆ | −0.021 | 0.45 | 27 | 92 | Example |
| dispersion 7 | | | | | | | | | |
| Aqueous | acetic acid | 0.95 | A | HClO₄ | −0.056 | 0.45 | 10 | 95 | Example |
| dispersion 8 | | | | | | | | | |
| Aqueous | malic acid | 1.6 | A | HClO₄ | −0.056 | 0.45 | 14 | 95 | Example |
| dispersion 9 | | | | | | | | | |
| Aqueous | succinic | 0.5 | A | HNO₃ | −0.046 | 0.45 | 18 | 92 | Example |
| dispersion 10 | anhydride | | | | | | | | |
| Aqueous | succinic | 0.5 | A | HIO₄ | −0.065 | 0.45 | 16 | 95 | Example |
| dispersion 11 | anhydride | | | | | | | | |
| Aqueous | butyric acid | 1.3 | B | HClO₄ | −0.056 | 0.45 | 13 | 95 | Example |
| dispersion 12 | | | | | | | | | |
| Aqueous | butyric acid | 1.3 | B | HCl | −0.007 | 0.45 | 63 | 75 | Comparative |
| dispersion 13 | | | | | | | | | Example |
| Aqueous | — | 0 | — | HPF₆ | −0.021 | 0.45 | 61 | 77 | Comparative |
| dispersion 14 | | | | | | | | | Example |

* B value: G. Jones and M. Dole, J. Am. Chem. Soc., 51 2950 (1929)
* the content of the carboxylic compound represents the content of the carboxylic compound (mole) added relative to the content of the titanium (mole).

As is clear from the results of Table 1, the aqueous dispersions 5 to 12 of the present invention were found to have a small average particle size, high transparency and an extremely high practical use.

### Example 2

### Production of Aqueous Dispersions 1 to 20

According to the description of Table 2, 200 cc of a titanium tetrachloride solution (4 mass %) was kept at room temperature (26° C.) and neutralized with an ammonia solution to separate out amorphous titanium hydroxide, and heated in a water bath at 70° C. for 30 minutes and a precipitate was filtrated by distilled water and a filter cake was washed. And then a carboxylic compound and an acid compound containing a bulky anion were added in the solution and heated in a water bath at 80° C. for 4 hours to prepare respective aqueous dispersions of titanium oxide ultrafine particles (hereinafter, a timing of addition of the acid compound containing a bulky anion: C). Alternatively, 200 cc of a titanium tetrachloride solution (4 mass %) was kept at room temperature (26° C.) and neutralized with an ammonia solution to separate out amorphous titanium hydroxide, and a carboxylic compound was added therein and heated in a water bath at 80° C., and then ¼ amount of an acid compound containing a bulky anion was added, 1 hour later ¼ amount thereof, further 1 hour later ¼ amount thereof, and still further 1 hour later ¼ amount thereof were added, and then heated for 1 hour to produce respective aqueous dispersions of titanium oxide ultrafine particles (hereinafter, a timing of addition of the acid compound containing a bulky anion: D).

The respective aqueous dispersions were air dried to obtain titanium oxide ultrafine particles, and the respective collected titanium oxide ultrafine particles were confirmed to have anatase crystal structures by X-ray diffraction.

Table 2 shows the kinds of the carboxylic compound, the contents of the carboxylic compound (mole) per 1 mole of the titanium, the timings of addition of the acid compound containing a bulky anion (the acid compound containing a bulky anion was added at the timing of addition C or D), and the contents of the acid compound containing a bulky anion per 1 mole of the titanium, which were used for respective aqueous dispersions.

Table 2 shows respective results of an average size of 150 titanium oxide ultrafine particles found by TEM observation, and a transmittance at 800 nm wavelength of 4 mass % of the aqueous dispersions (optical path length of 1 cm).

The obtained aqueous dispersions of titanium oxide fine particles were air dried to obtain titanium oxide fine particles.

The crystallinity, volume-weighted average particle size and light transmittance of the respective titanium oxide fine particles were measured as described below. The results are shown in Table 2.

### <Measurement of X-Ray Diffraction (XRD) Spectrum>

The obtained titanium oxide fine particles were respectively measured at 23° C. on RINT 1500 from Rigaku Corporation (X-ray source: copper Kα ray, wavelength: 1.5418 Å) to obtain X-ray diffraction (XRD) spectra. All of them were anatase titanium oxides (crystallrity).

### <Measurement of Volume-Weighted Average Particle Size>

The aqueous dispersion to be measured was dropped onto a carbon-deposited copper mesh (microgrid) and dried, and then observed at 5 fields of views or more at a magnification of ×25,000 by using a transmission electron microscope H-9000 UHR Model from Hitachi, Ltd. (accelerating voltage: 200 kV, degree of vacuum in observation: about 7.6×10⁻⁹ Pa) to obtain a volume-weighted average particle size of 150 titanium oxide fine particles.

### <Measurement of Light Transmittance>

Each of the aqueous dispersions containing 4 mass % of the obtained titanium oxide fine particles and distilled water as a reference were respectively poured into quartz cells having an optical path length of 1 cm and measured for a light transmittance at 800 nm wavelength on a spectrophotometer U-3310 from Hitachi, Ltd.

TABLE 2

| | Carboxylic acid compound | | | Timing of | B | Content | Average | Transmittance | |
|---|---|---|---|---|---|---|---|---|---|
| | | Content | Kind | addition of | value of acid | of acid | particle size | at 800 nm | |
| | Kind | (mol fr.) | of acid | acid | (*) | (mol fr.) | (nm) | wavelength (%) | |
| Aqueous dispersion (1) | — | 0 | HNO₃ | C | −0.046 | 0 | 57 | 78 | Comparative |
| | | | | | | | | | Example |
| Aqueous dispersion (2) | acetic acid | 1 | HClO₄ | C | −0.056 | 0.5 | 10 | 96 | Example |
| Aqueous dispersion (3) | sodium acetate | 1 | HClO₄ | C | −0.056 | 0.5 | 11 | 95 | Example |
| Aqueous dispersion (4) | sodium acetate | 1 | NaClO₄ | C | −0.056 | 0.5 | 10 | 95 | Example |
| Aqueous dispersion (5) | tartaric acid | 1 | HNO₃ | C | −0.046 | 0.5 | 12 | 93 | Example |
| Aqueous dispersion (6) | potassium | 1 | HNO₃ | C | −0.046 | 0.5 | 10 | 94 | Example |
| | tartrate | | | | | | | | |
| Aqueous dispersion (7) | citric acid | 1 | HNO₃ | C | −0.046 | 0.5 | 16 | 94 | Example |
| Aqueous dispersion (8) | sodium citrate | 1 | HNO₃ | C | −0.046 | 0.5 | 16 | 94 | Example |
| Aqueous dispersion (9) | acetic acid | 1 | HIO₄ | C | −0.065 | 0.5 | 9 | 96 | Example |
| Aqueous dispersion (10) | acetic acid | 0.5 | HIO₄ | C | −0.065 | 0.5 | 10 | 95 | Example |
| Aqueous dispersion (11) | acetic acid | 0.33 | HIO₄ | C | −0.065 | 0.5 | 15 | 92 | Example |
| Aqueous dispersion (12) | acetic acid | 0.33 | NaIO₄ | C | −0.065 | 0.5 | 18 | 92 | Example |
| Aqueous dispersion (13) | acetic anhydride | 0.33 | HIO₄ | C | −0.065 | 0.5 | 8 | 96 | Example |
| Aqueous dispersion (14) | acetic anhydride | 0.1 | HIO₄ | C | −0.065 | 0.5 | 14 | 92 | Example |
| Aqueous dispersion (15) | acetic acid | 1 | HCl | C | −0.007 | 0.5 | 45 | 86 | Comparative |
| | | | | | | | | | Example |
| Aqueous dispersion (16) | acetic acid | 1 | HBr | C | −0.042 | 0.5 | 16 | 94 | Example |
| Aqueous dispersion (17) | acetic acid | 1 | HI | C | −0.068 | 0.5 | 8 | 97 | Example |
| Aqueous dispersion (18) | acetic acid | 1 | KClO₃ | C | −0.024 | 0.5 | 20 | 91 | Example |
| Aqueous dispersion (19) | acetic acid | 1 | HClO₄ | D | −0.056 | 0.5 | 14 | 93 | Example |
| Aqueous dispersion (20) | acetic acid | 1 | HIO₄ | D | −0.065 | 0.5 | 12 | 94 | Example |

* B value: G. Jones and M. Dole, J. Am. Chem. Soc., 51 2950 (1929)
* the content of the carboxylic compound represents the content of the carboxylic compound (mole) added relative to the content of the titanium (mole).

As is clear from the results of Table 2, the aqueous dispersions 2 to 14 and 16 to 20 of the present invention were found to have a small average particle size, high transparency and an extremely high practical use.

### Example 3

### Production of Aqueous Dispersions a to g

According to the description of Table 3, a carboxylic compound was added in 30 cc of a zirconium butoxide (from Aldrich) and stirred for 10 minutes, and then added to distilled water including an acid compound containing a bulky anion to obtain respective suspensions having a concentration of 4 mass % in terms of zirconium oxide. The respective suspensions were loaded in an autoclave and subjected to hydrothermal treatment under a pressure of 150 atmospheres at 150° C. for 20 hours to produce respective suspensions containing zirconium oxide fine particles.

The respective suspensions (aqueous dispersions) were air dried to obtain zirconium oxide ultrafine particles, and the respective collected zirconium oxide ultrafine particles were confirmed to be crystalline by X-ray diffraction.

Table 3 shows the kinds and contents of the carboxylic compound and acid compound containing a bulky anion (number of moles per 1 mole of titanium), and respective results of an average size of 150 titanium oxide ultrafine particles found by TEM observation, and a transmittance at 800 nm wavelength of 4 mass % of the aqueous dispersions, which were used for respective aqueous dispersions.

The obtained aqueous dispersions of zirconium oxide fine particles were respectively air dried to obtain zirconium oxide fine particles.

The crystallinity, volume-weighted average particle size and light transmittance of the respective zirconium oxide fine particles were measured as described below. The results are shown in Table 3.

### <Measurement of X-Ray Diffraction (XRD) Spectrum>

The obtained zirconium oxide fine particles were respectively measured at 23° C. on RINT 1500 from Rigaku Corporation (X-ray source: copper Kα ray, wavelength: 1.5418 Å) to obtain X-ray diffraction (XRD) spectra. All of the obtained zirconium oxide fine particles were crystalline.

### <Measurement of Volume-Weighted Average Particle Size>

The aqueous dispersion to be measured was dropped onto a carbon-deposited copper mesh (microgrid) and dried, and then observed at 5 fields of views or more at a magnification of ×25,000 by using a transmission electron microscope H-9000 UHR Model from Hitachi, Ltd. (accelerating voltage: 200 kV, degree of vacuum in observation: about 7.6×10⁻⁹ Pa) to obtain a volume-weighted average particle size of 150 zirconium oxide fine particles.

### <Measurement of Light Transmittance>

Each of the aqueous dispersions containing 4 mass % of the obtained zirconium oxide fine particles and distilled water as a reference were respectively poured into quartz cells having an optical path length of 1 cm and measured for a light transmittance at 800 nm wavelength on a spectrophotometer U-3310 from Hitachi, Ltd.

TABLE 3

| | Carboxylic acid | | | | | Average | Transmittance | |
|---|---|---|---|---|---|---|---|---|
| | compound | | | B value | Content of | particle | at 800 nm | |
| | | Content | Kind of | of acid | acid | size | wavelength | |
| | Kind | (mol fr.) | acid | (*) | (mol fr.) | (nm) | (%) | |
| Aqueous | — | 0 | HNO₃ | −0.046 | 0.2 | 50 | 75 | Comparative |
| dispersion a | | | | | | | | Example |
| Aqueous | acetic | 1.0 | — | — | 0 | 35 | 79 | Comparative |
| dispersion b | acid | | | | | | | Example |
| Aqueous | acetic | 1.0 | HNO₃ | −0.046 | 0.2 | 11 | 93 | Example |
| dispersion c | acid | | | | | | | |
| Aqueous | tartaric | 1.2 | HNO₃ | −0.046 | 0.2 | 12 | 93 | Example |
| dispersion d | acid | | | | | | | |
| Aqueous | malic | 1.2 | HNO₃ | −0.046 | 0.2 | 12 | 93 | Example |
| dispersion e | acid | | | | | | | |
| Aqueous | acetic | 1.0 | HClO₄ | −0.056 | 0.2 | 9 | 95 | Example |
| dispersion f | acid | | | | | | | |
| Aqueous | acetic | 1.0 | HCl | −0.007 | 0.2 | 27 | 83 | Comparative |
| dispersion g | acid | | | | | | | Example |

* B value: G. Jones and M. Dole, J. Am. Chem. Soc., 51 2950 (1929)
* the content of the carboxylic compound represents the content of the carboxylic compound (mole) added relative to the content of the zirconium (mole).

As is clear from the results of Table 3, the aqueous dispersions c to f of the present invention were found to have a small average particle size, high transparency and an extremely high practical use.

The aqueous dispersion of metal oxide fine particles of the present invention can be widely used as a very useful material for optical filters, coatings, fibers, cosmetics, lenses or the like, because they have extremely high transparency in the visible range and a certain wavelength range.

What is claimed is:

1. An aqueous dispersion of metal oxide fine particles, comprising:
metal oxide fine particles;
a carboxylic compound; and
an acid compound containing a bulky anion having B value of −0.01 or less in Equation (1),
wherein the metal oxide fine particles, the carboxylic compound and the acid compound containing a bulky anion are dispersed in an aqueous solution, and the aqueous dispersion of metal oxide fine particles has a light transmittance at 800 nm wavelength of 90% or more:
η=η⁰(1+A√c+Bc) Equation (1)
where η represents a viscosity of a solution, η⁰ represents a viscosity of a solvent, A and B respectively represent an inherent constant value of an acid, and c represents a concentration of the solution.

2. The aqueous dispersion of metal oxide fine particles according to claim 1, wherein the carboxylic compound is at least one selected from carboxylic acids, carboxylic anhydrides and salts thereof.

3. The aqueous dispersion of metal oxide fine particles according to claim 1, wherein the bulky anion is at least one selected from Br⁻, I⁻, PF₆⁻, ClO₃⁻, NO₃⁻, ClO₄⁻ and IO₄⁻.

4. The aqueous dispersion of metal oxide fine particles according to claim 1, wherein the metal oxide fine particles have a volume-weighted average particle size of 1 nm to 100 nm.

5. The aqueous dispersion of metal oxide fine particles according to claim 1, wherein a metal oxide constituting the metal oxide fine particles is any of a titanium oxide, a zirconium oxide and a composite oxide of titanium and zirconium.

6. The aqueous dispersion of metal oxide fine particles according to claim 1, wherein the metal oxide fine particles comprise crystalline metal oxide fine particles.

7. A method for producing an aqueous dispersion of metal oxide fine particles comprising:
subjecting a metal oxide precursor to heat treatment in the presence of a carboxylic compound and an acid compound so as to prepare metal oxide fine particles,
wherein the carboxylic compound is selected from carboxylic acids, carboxylic anhydrides and salts thereof, and the acid compound comprises at least one counter ion selected from Br⁻, I⁻, PF₆⁻, ClO₃⁻, NO₃⁻, ClO₄⁻ and IO₄⁻.

8. The method for producing an aqueous dispersion of metal oxide fine particles according to claim 7, wherein the metal oxide precursor comprises any of an organic metal compound, a metal salt and a metal hydroxide.
